(19) United States
(12) Patent Application Publication
(10) Pub. No.: US 2010/0104083 A1
(43) Pub. Date: Apr. 29, 2010

(54) PROVIDING TELEPHONE DIRECTORY ASSISTANCE

(75) Inventors: Ori Berman, Ramat-Hasharon (IL); Ronen David, Herzelia (IL); Roy Shilkrot, Negba (IL)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Comverse, Ltd., Tel Aviv (IL)

(21) Appl. No.: 12/603,954

(22) Filed: Oct. 22, 2009

Related U.S. Application Data
(60) Provisional application No. 61/107,385, filed on Oct. 22, 2008.

(51) Int. Cl. H04M 3/42; G06F 17/30

(52) U.S. Cl. 379/218.01; 707/E17.001

(57) ABSTRACT

There is provided a method for providing telephone directory assistance. The method includes (a) receiving, via a communication network, first information concerning a telephone call being proposed for a telephone having a first telephone number, (b) obtaining second information relating to a prior call involving the first telephone number, (c) obtaining a resultant telephone number, based on the first information and the second information, and (d) outputting the resultant telephone number, via the communication network.

### BACKGROUND OF THE INVENTION

1. Field of the Invention

The present disclosure relates to providing telephone directory assistance, and more particularly, to providing a telephone number for a proposed call, based on a query submitted by a calling party.

2. Description of the Related Art

A user of a telephone can access a telephone directory on a network, such as the Internet, and search for a telephone number of a party. However, to search the telephone directory, the user would ordinarily need to know the party's name or address. Additionally, such a search may difficult to manage on a cellular telephone, which typically has a relatively small screen and limited capability to accept alphabetic input.

As an alternative to the telephone directory, the user may attempt to obtain the telephone number by presenting a query to a search engine that searches a database, and based on the query, returns one or more results. The search engine may treat the query as a string of keywords, and return results showing any of the keywords. The results are ranked according to some parameter such as the frequency of the keywords or how closely together the keywords are located with respect to one another. In a more sophisticated searching technique, the search engine parses the query, and conducts a search based on a semantic understanding of the query. However, regardless of the manner in which the query is interpreted, Internet searching often returns many irrelevant results.

There is a need for telephone directory assistance that returns a telephone number, or a refined list of telephone numbers, even for a case where a user does not necessarily provide information that fully identifies a party that the user wishes to call.

### SUMMARY OF THE INVENTION

There is provided a method for providing telephone directory assistance. The method includes (a) receiving, via a communication network, first information concerning a telephone call being proposed for a telephone having a first telephone number, (b) obtaining second information relating to a prior call involving the first telephone number, (c) obtaining a resultant telephone number, based on the first information and the second information, and (d) outputting the resultant telephone number, via the communication network.

### BRIEF DESCRIPTION OF THE DRAWINGS

FIG. 1 is a block diagram of a system that provides telephone directory assistance to a user of a telephone.

FIG. 2 illustrates a fourth order degree of connection in a network of contacts.

FIG. 3 is a block diagram of a client that may be downloaded to telephone.

FIG. 4 is a flowchart of a method, performed by a query engine in the system of FIG. 1, for making a semantic search for a telephone number.

FIG. 5 is a block diagram showing additional aspects of the query engine of FIG. 1.

FIG. 6 is a block diagram showing an example of a use of the query engine FIG. 1 that includes interfacing with an advertising application.

FIG. 7 is a block diagram of a computer system configured to provide services of the query engine of FIG. 1.

A component or a feature that is common to more than one drawing is indicated with the same reference number in each of the drawings.

### DESCRIPTION OF THE INVENTION

The present document discloses a technique for searching for a telephone number based on a query presented from a calling telephone. The query may be parsed semantically, that is, to determine a meaning of words, phases and concepts presented in the query. Additionally, the calling telephone can provide a context in which the query is evaluated, for example based on a location of the calling telephone, or based on prior usage of the calling telephone.

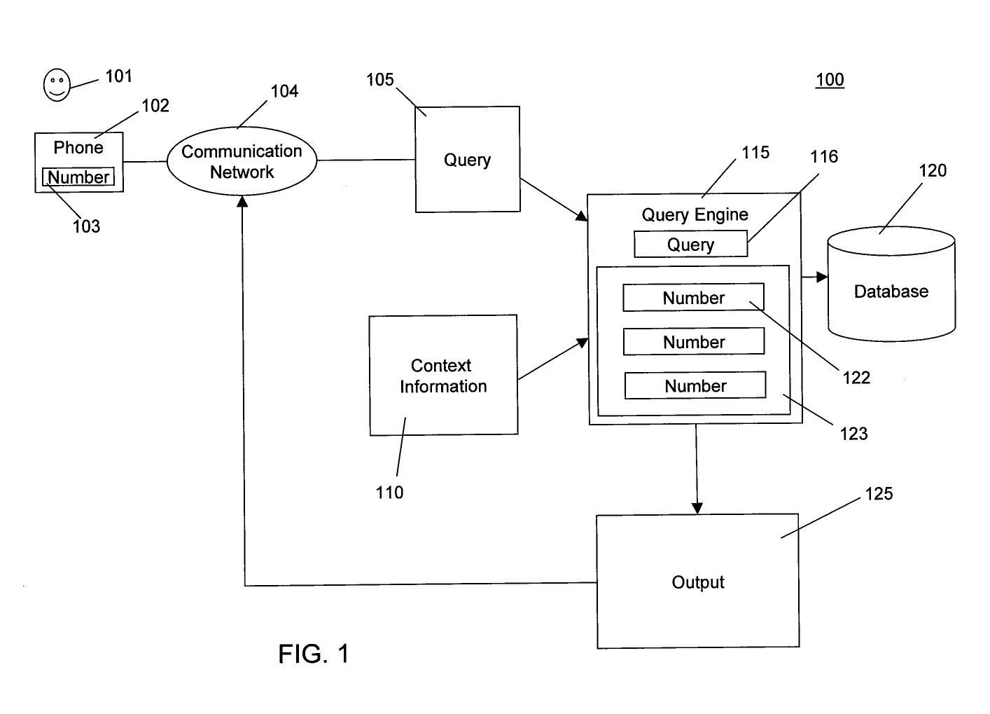

FIG. 1 is a block diagram of a system 100 that provides telephone directory assistance to a user 101 of a telephone 102 having a telephone number 103. System 100 includes a query engine 115 and a database 120, and operates in conjunction with a communication network 104, e.g., the Internet.

Telephone 102 includes a processor (not shown) and a memory (not shown) that contains instructions that are readable by the processor, and that control the processor to perform operations described herein. Telephone 102 includes an audio interface for user 101 to conduct audio communications, a display for a presentation of images to user 101, and a keypad with which user 101 can input alpha and numeric data. Telephone 102 may also include a speech recognition module to receive spoken commands from user 101, and a speech synthesizer module to provide information to user 101 in audio form.

Query engine 115 receives a query 105 from telephone 102, via communication network 104. Query 105 includes information concerning a proposed telephone call that user 101 wishes to make.

Query engine 115 obtains context information 110 relating to a context of telephone 102. Context information 110 may indicate, for example, a location of telephone 102, or information relating to a prior call involving telephone number 103. Context information 110 could also indicate known contacts of user 101, interests of user 101, user 101's business, and general profile information for user 101.

Context information 110 may be provided by components that are parts of query engine 115, or by components, e.g., servers and databases, that are external to query engine 115. When provided by components that are external to query engine 115, such components can be coupled to communication network 104, and accessed by query engine 115 via communication network 104.

Query engine 115 formulates a query 116 based on query 105 and context information 110, and with query 116, searches database 120 to find one or more telephone numbers relevant to query 105.

Database 120 is a database of information concerning telephone subscribers, such as names, addresses, and types of business, and also includes telephone numbers of the telephone subscribers.

From the search of database 120, query engine 115 may obtain a single result, namely a resultant telephone number 122. Thereafter, query engine 115 outputs resultant telephone number 122 as an output 125, via communication network 104. Output 125 may be sent by HTTP, or may be sent as a text message.

Query engine 115 allows user 101 to dial via name or query, and thus frees user 101 from having to first have a precise phone number. User 101 is not required to have a telephone directory, and is not limited to the very minimal queries possible with conventional directory inquiries.

Resultant telephone number 122 can be routed to telephone 102 via communication network 104. Thereafter, either user 101 can use resultant telephone number 122 to place the call, or telephone 102 can automatically make the call. As an alternative, resultant telephone number 122 can be routed to a call routing device (not shown) that is coupled to communication network 104 to facilitate the call between telephone 102 and a telephone associated with resultant telephone number 122.

Although query 116 is described herein as being based, in part, on context information 110, and as such, restricted by context information 110, query 116 need not be based on context information 110, but instead, just based on query 105. Accordingly, query engine 115 would structure query 116 in more general terms, obtain a plurality of results from the search of database 120, and then use context information 110 to extract a relevant subset of the plurality of results, and rank the results in the subset, thus yielding ranked results 123. Ranked results 123 may be organized as a list, with higher-ranking results placed earlier or higher in the list than lower-ranking results. Output 125 will contain ranked results 123, and ranked results 123 will be routed to telephone 102.

If telephone 102 is a fixed line, the location of telephone 102 can be obtained from a billing statement or other document relating to telephone number 103. However, telephone 102 can be a cellular telephone, and a telephone network (not shown) within which telephone 102 is operating can be a cellular network. In this case the telephone network may submit a geographical location of telephone 102, e.g., by way of an identity of a serving base station, and query engine 115 can use this geographical location as part of context information 110.

Context information 110 contains information relating to a prior call involving telephone number 103, for example, a listing of contact numbers called from telephone number 103, or that have called telephone number 103, and information concerning prior requests made by user 101. Thus, if user 101 requests a particular name, and there are several examples of the name found in the search of database 120, query engine 115 would rank, at the top of ranked results 123, a person of that name who has in the past called or been called from telephone number 103.

Context information 110 also extends to cover information relating to a telephone number of a B-party that user 101 seeks to call, and also to a telephone number of a third party with which the telephone number of a B-party has previously conducted a call. For example, context information 110 may extend to contact number information belonging to the contacts in telephone 102's contact information, so that a friend of a friend would also be ranked more highly in ranked results 123. The situation can be extended to any degree of connectedness.

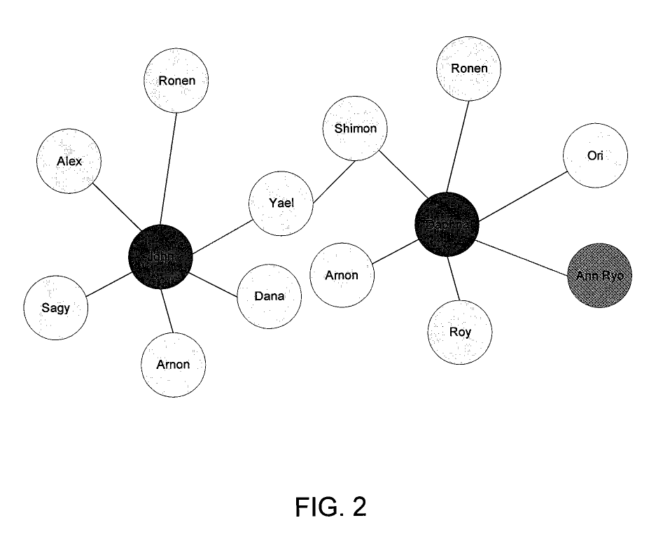

FIG. 2 illustrates a fourth order degree of connection in a network of contacts, in which John queries the name Ann Ryo. John has never before called Ann Ryo, but John has previously called Yael, who has previously called Shimon, who has previously called Daphna who, in turn, has called Ann Ryo. This particular Ann Ryo would be ranked in ranked results 123.

Referring again to FIG. 1, context information 110 may include categories, e.g., professions, of contacts called from telephone number 103. Thus, for example, if telephone number 103 has recently called a telephone number of a member of a given profession, then results belonging to the same profession may be preferred by query engine 115. If user 101 has recently increased the number of calls made to members of that profession, then there is an even greater likelihood that a new request from user 101 may be intended for yet another member of the profession.

System 100 provides user 101 with an ability to use free test to dial to a B-party. More specifically, system 100 provides telephone 102 with a capability for user 101 to enter free text such as personal names, business names, types of business, or sentences instead of digits. System 100 uses networked databases, e.g., database 120, to find one or more best match phone numbers. The results may be personally adapted to user 101, using context information 110.

User 101 is able to call B-party even though user 101 does not know B-party's phone number. Instead user 101 can enter free text such as B-party's name, classification, e.g., “polo garage”, or description, e.g. “tickets to Paul McCartney concert in September”, and query engine 115 then uses the entered text, i.e., query 105, together with context information 110, related to the telephone identity, in order to find the relevant phone number. Context information 110 allows query engine 115 to adjust raw search results, personally, for user 101, so that if two different users send the same request, the two users will not necessarily receive the same results.

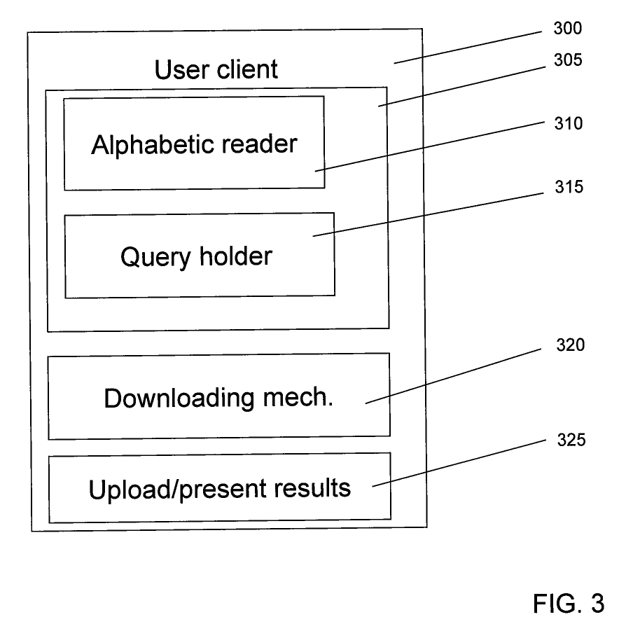

FIG. 3 is a block diagram of a client 300 that may be downloaded to the memory of telephone 102. Client 300 provides an interface for user 101 to use telephone 102 to input textual queries, send query 105 in a suitable format to query engine 115, e.g., as a correctly addressed text message, and then present output 125, for example on a screen of telephone 102, in a manner in which user 101 can select a telephone number of interest for dialing.

Client 300 includes an input 305 to receive query 105 as a text-based search query. Input 305 includes an alphabetic reader 310 for reading alphabetic input from a keypad of telephone 102, and a query holder 315 for storing query 105 and echoing query 105 to the screen of telephone 102. A downloading mechanism 320 downloads query 105 to query engine 115 for context based searching for a telephone number. Client 300 then receives output 125 from query engine 115 in upload unit 325 to allow user 101 to select a result for dialing.

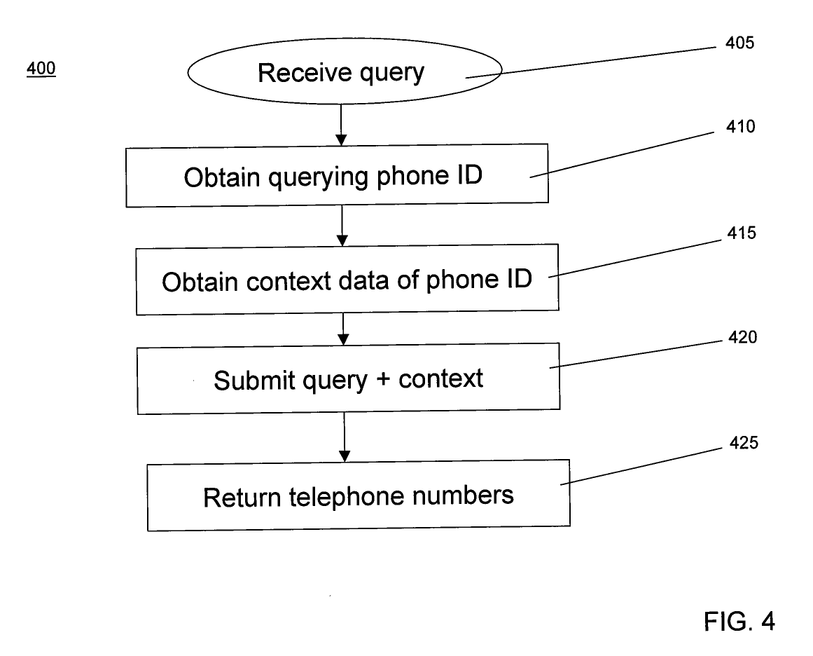

FIG. 4 is a flowchart of a method 400, performed by query engine 115, for making a semantic search for a telephone number. Method 400 commences with step 405.

In step 405, query engine 115 receives query 105 from telephone 102. Query 105 relates to a proposed call. From step 405, method 400 progresses to step 410.

In step 410, query engine 115 obtains identity information of telephone 102, e.g., telephone number 103. From step 410, method 400 progresses to step 415.

In step 415, query engine 115 obtains context information 110 concerning telephone 102 and/or telephone number 103. From step 415, method 400 progresses to step 420.

In step 420, query engine 115 prepares query 116 and searches database 120. As noted above, context information 110 may in one embodiment be incorporated into query 116 to modify the search of database 120, and in another embodiment may be used to rank results found by a search in which query 116 is based on query 105 alone. From step 420, method 400 progresses to step 425.

In step 425, query engine 115 receives results from the search of database 120, and sends the results to telephone 102.

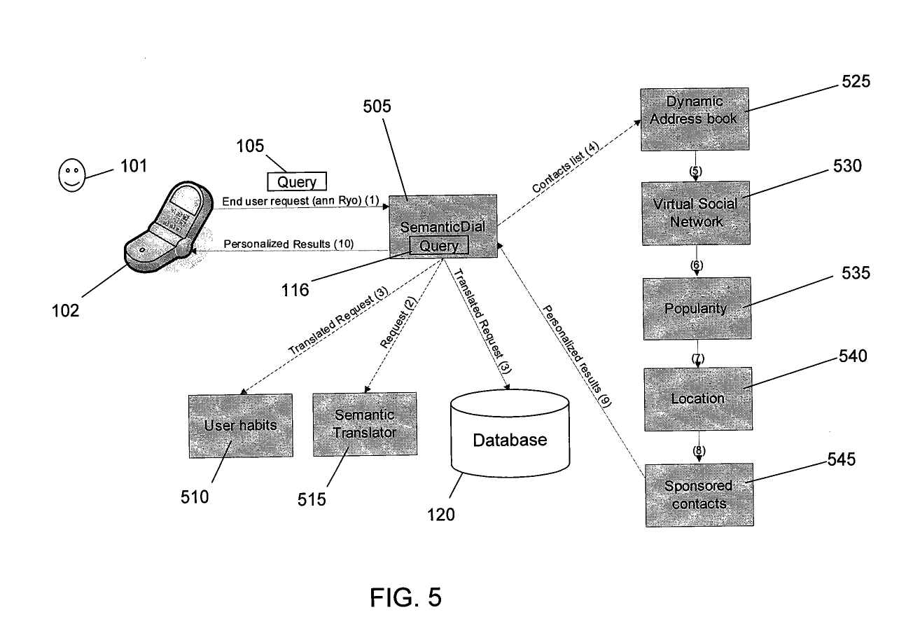

FIG. 5 is a block diagram showing additional aspects of query engine 115. Query engine 115 includes a semantic dial module 505, a user habits module 510, a semantic translator 515, a dynamic address book 525, a virtual social network 530, a popularity module 535, a location module 540, and a sponsored contacts module 545.

User habits module 510 contains information concerning habits of user 101, and other information known about or provided by user 101. Semantic translator 515 performs a semantic analysis of query 105, and translates query 105 into a valid database request, i.e., query 116.

For example, assume that user 101 has a problem with his car and submits a query 105 requesting a “polo garage”. Semantic translator 515 would determine that the “polo” is a model of automobile, and would thus prepare query 116 for a garage that is affiliated with a manufacturer of that particular model of automobile.

Dynamic address book 525 is created and regularly modified by semantic dial module 505. More specifically, semantic dial module 505 regularly analyzes end-user phone calls and automatically modifies dynamic address book 525 with call information, adding new callers and recognizing common information or patterns regarding the calls. Dynamic address book 525 may be used as a standard network address book to be accessed directly so that user 101 can access previously dialed numbers, and can even be made available via a web application, etc. Semantic dial module 505 may use dynamic address book 525 to find B-party's phone number directly without needing a search if dynamic address book 525 includes B-party's phone number.

Using dynamic address book 525, semantic dial module 505 builds a map of connections and relationships to generate virtual social network 530, which represents a social network of user 101. From virtual social network 530, semantic dial module 505 finds a contact of user 101, and may look in this contact's dynamic address book for B-party's phone number.

For example, referring again to FIG. 2, if John is looking for Ann Ryo's phone number and there is someone of that name who is a friend of one of John's friends, then there is an increased likelihood that this is the Ann Ryo for which John is looking. Semantic dial module 505 can find Ann Ryo's phone number by analyzing John's virtual social network and each of the dynamic address books of succeeding members of the network. Semantic dial module 505 finds that John knows Yael, who knows Shimon, who knows Daphna, who knows Ann Ryo.

Also, if a particular contact, maybe one of the contacts if FIG. 2, recently called user 101, such a contact could be regarded as having a greater likelihood of being sought by user 101.

Query engine 115, to determine a set of results, can consider information relating to the telephone number that user 101 wishes to call. For example, returning to FIG. 5, in the event that semantic dial module 505 finds more than one result matching the request criteria, popularity module 535 works with virtual social network 530 to analyze communication volume of each potential candidate for B-party. A B-party candidate who is more popular than other B-party candidates, whether based on incoming call volume, incoming short message service (SMS) volume, number of direct connections to other users in virtual social network 530, or other suitable criteria, may be positioned higher in ranked results 123.

Popularity module 535 considers factors such as (a) a number of calls previously conducted between telephone number 103 and a telephone number of a B-party candidate, (b) an amount of time spent during calls previously conducted between telephone number 103 and a telephone number of a B-party candidate, (c) a number of calls previously conducted between a telephone number of a B-party candidate and other telephone numbers, and (d) an amount of time spent during calls previously conducted between a telephone number of a B-party candidate and other telephone numbers.

Location unit 540 uses geographic criteria to prioritize search results. If user 101 is looking for a restaurant or a garage, results geographically closer to user 101 will be higher in ranked results 123, and vice-versa, results that are not in the same geographical area can be excluded from ranked results 123.

Sponsored contacts module 545 contains data concerning a sponsor that pays to have its telephone number placed higher in ranked results 123. That is, an operator of query engine 115 can charge the sponsor for preferential treatment. Thus, the sponsor is an entity having a telephone number that is designated as deserving preferential treatment over a telephone number of an entity that is not designated as deserving the preferential treatment. When semantic dial module 505 receives a plurality of results from the search of database 120, semantic dial module 505 extracts a subset of plurality of results based on contact information 110. Sponsored contacts module 545 prioritizes the subset so that in a list in ranked results 123, the telephone number of the sponsor is positioned earlier than the telephone number of the other entity.

User habits module 510 analyzes user 101's requests and learns habits and draws an inference as to what types of information user 101 is interested. Thereafter, user habits module 510 can provides results of the analysis to a third-party application that wishes to obtain information concerning user 101's preferences. For example if user 101 requests a telephone number of a sports shop, user habits module 510 analyzes the request and notes details relating thereto in dynamic address book 525. User habits module 510 can then supply, to an external advertising application, information concerning user 101's interest in sports, and offer user 101 a coupon or show user 101 a sports-related commercial. In general, user habits module 510 associates an attribute, e.g., interest in sports, with telephone number 103 based on information in query 105, and provides to user 101, information concerning a service or a product, based on the attribute.

Operations of user habits module 510, semantic translator 515, dynamic address book 525, virtual social network 530, popularity module 535, and location module 540 can be further employed together, to better refine the results.

For example, consider operations of dynamic address book 525 and location module 540. A person can be provided with services located close to the person. Cues can be obtained from user details. Thus if a list of results includes someone who works in the same place as user 101, then that someone may be given high priority in the results list. Popularity module 535 considers general popularity of a given result as a factor.

As a further example, consider again the case where semantic translator 515 determines that in user 101's request for “polo garage”, the “polo” is a model of automobile and would thus prepare query 116 for a garage that is affiliated with a manufacturer of that particular model of automobile. Location module 540 would then ensure that the garages nearest to the caller are prioritized.

User 101 requesting “Tickets to Paul McCartney's concert in September” may be given the box office of a completely different concert depending on the country from which the request was made.

As mentioned above during the discussion of FIG. 1, context information 110 may be provided by components that are parts of query engine 115, or by components that are external to query engine 115. In FIG. 5, semantic dial module 505, user habits module 510, semantic translator 515, dynamic address book 525, virtual social network 530, popularity module 535, location module 540, and sponsored contacts module 545 are potential sources of context information 110, configured as components of query engine 115.

FIG. 5 includes arrows designated by labels (1)-(10) that indicate a process flow in system 100.

At arrow (1), user 101 enters a free-text request using client 300 (FIG. 3) or via SMS, and sends it in query 105, to semantic dial module 505.

At arrow (2), semantic dial module 505 passes query 105 to semantic translator 54. Semantic translator 54 translates the free-text request to a database request, i.e., query 116, and returns query 116 to semantic dial module 505.

There are two occurrences of arrow (3), because processes represented by these two arrows are being executed in parallel with one another.

At arrow (3) between semantic dial module 505 and database 120, semantic dial module 505 searches database 120. Database 120 is not necessarily limited to a single local database, but instead is contemplated as encompassing external databases, for example, databases of telephone directory white pages, advertising databases, and other information accessible over the Internet. From the search, semantic dial module 505 may receive either a single result, or more likely, a plurality of results.

At arrow (3) between semantic dial module 505 and user habits module 510, the request from query 105 is forwarded to user habits module 510, which logs the request, thus maintaining a log of previous requests, and uses it to learn about habits and personal preferences of user 101.

At arrows (4)-(9), semantic dial module 505 forwards the results that were returned from the search of database 120, to each of dynamic address book 525, virtual social network 530, popularity module 535, location module 540, and sponsored contacts module 545. These modules both minimize and prioritize the results to match user 101, personally.

At arrow (10) semantic dial module 505 passes results to telephone 102. In a case in which there is only one match, system 100 automatically sets up the phone call between user 102 and the B-party, so that system 100 gives the impression of entering text as dialing. If a list is returned, then user 101 chooses, from the list, a number to dial.

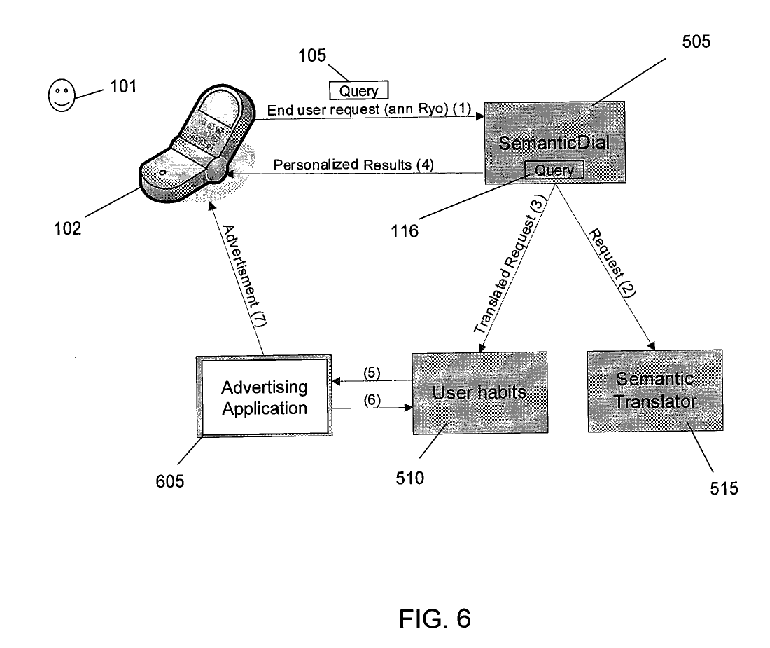

FIG. 6 is a block diagram showing an example of a use of query engine 115 that includes interfacing with an advertising application 605. Advertising application 605 may be a component of query engine 115, or an external component, on a system remotely located from query engine 115, for an external third-party entity. FIG. 6 includes arrows designated by labels (1)-(7) that indicate a process flow in system 100.

At arrow (1), user 101 enters a free-text request using client 300 (FIG. 3) or via SMS, and sends it in query 105, to semantic dial module 505.

At arrow (2), semantic dial module 505 passes the request to semantic translator 515. Semantic translator 515 translates the free-text request to a database request, i.e., query 116, and returns query 116 to semantic dial module 505. As described above, semantic dial module 505 searches database 120, which returns results.

At arrow (3), semantic dial module 505, in parallel with the submission of the request to semantic translator 515, forwards the request from query 105 the user habits module 510. User habits module 510 logs the request, and learns about personal preferences of user 101.

At arrow (4), semantic dial module 505 sends a personalized list of results to telephone 102.

At arrow (5), advertising application 605, which may register with query engine 115 for particular events, is notified when a certain search criterion matches an event for which advertising application 605 is registered.

At arrow (6), advertising application 605 inquires about overall uses, for example about queries such as “return all users who have shown a recent interest in sports”.

At arrow (7), advertising application 605 sends a special offer, such as a discount or an advertisement, based on user 101's search criteria in one or more query 105 and personal preferences.

As mentioned above, an operator of query engine 115 can charge for contacts to appear higher in a list of results. Through operation of user habits module 510, the operator is further able to learn about preferences of user 101 so that the operator can offer more relevant content and services. Thus, targeted advertising campaigns can be managed.

User 101 is thus encouraged to remain with his/her existing phone provider, as the provider's services tend to get more and more relevant as time goes on. That is to say, system 100 provides a certain quality of stickiness.

The results sent to telephone 102 may include material related to the choice and additional material related to the request. The results may thus include the contacts themselves, related content, and other results, which may be provided together or separately. User 101 can also configure query engine 115, through client 300, regarding the way in which user 101 wants to receive results. Query engine 115 may then send the most relevant results first, then allowing user 101 to see subsequent results upon request.

To use query engine 115, a telephone may need to support alphabetic characters. This is generally available on cellular and digital enhanced cordless telecommunications (DECT) telephones but is not universal. Some telephones may need a user client such as client 300, but an alternative embodiment may automatically accept letters and send for the search.

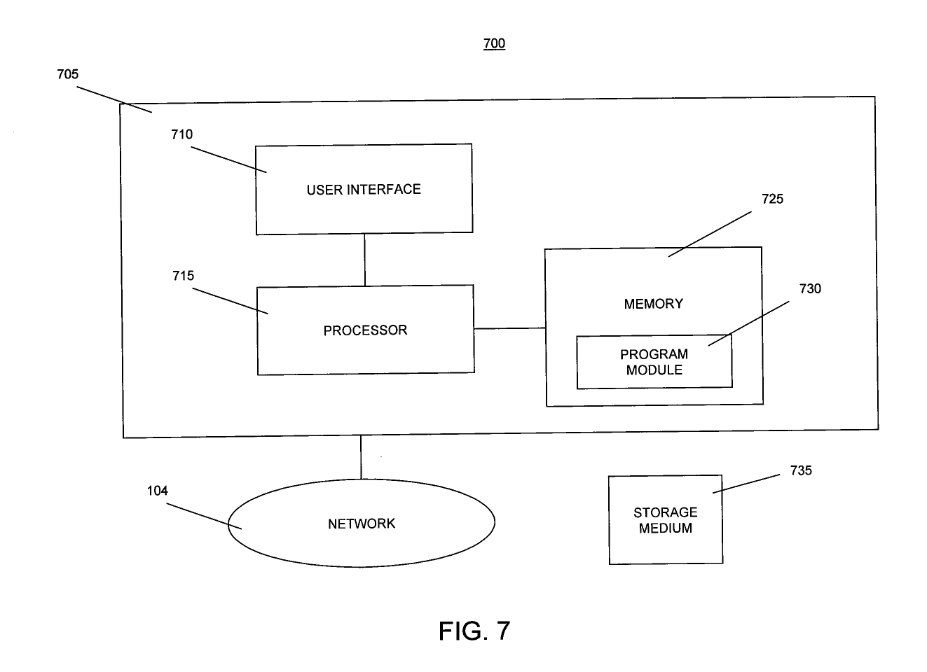

FIG. 7 is a block diagram of a computer system 700, configured to provide services of query engine 115. System 700 includes a computer 705 having a user interface 710, a processor 715 and a memory 725, and is coupled to communication network 104.

Processor 715 is configured of logic circuitry that responds to and executes instructions.

Memory 725 stores data and instructions that are readable by, and control operations of, processor 715. Memory 725 may be implemented in a random access memory (RAM), a hard drive, a read only memory (ROM), or a combination thereof. One of the components of memory 725 is a program module 730.

Program module 730 contains instructions for controlling processor 715 to execute the methods described herein. For example, as a result of execution of program module 730, processor performs the actions of query engine 115, and moreover, the actions of semantic dial module 505, user habits module 510, semantic translator 515, dynamic address book 525, virtual social network 530, popularity module 535, location module 540 and sponsored contacts module 545. Program module 730 may also contain instructions for implementing advertising module 605, and may further contain client 300 for downloading to telephone 102.

The term “module” is used herein to denote a functional operation that may be embodied either as a stand-alone component or as an integrated configuration of a plurality of sub-ordinate components. Thus, program module 730 may be implemented as a single module or as a plurality of modules that operate in cooperation with one another. Moreover, although program module 730 is described herein as being installed in memory 725, and therefore being implemented in software, it could be implemented in any of hardware (e.g., electronic circuitry), firmware, software, or a combination thereof.

Although computer 705 is represented herein as a standalone device, it is not limited to such, but instead can be coupled to other devices (not shown) via communication network 104. As such, the actions of semantic dial module 505, user habits module 510, semantic translator 515, dynamic address book 525, virtual social network 530, popularity module 535, location module 540, sponsored contacts module 545, and program module 730 may be distributed on devices throughout communication network 104.

User interface 710 includes an input device, such as a keyboard or speech recognition subsystem, for enabling an operator of computer 705 to communicate information and command selections to processor 715. User interface 710 also includes an output device such as a display or a printer. A cursor control such as a mouse, track-ball, or joystick, allows the operator to manipulate a cursor on the display for communicating additional information and command selections to processor 715.

Processor 715 outputs, via communication network 104, a result of an execution of the methods described herein.

While program module 730 is indicated as already loaded into memory 725, it may be configured on a storage medium 735 for subsequent loading into memory 725. Storage medium 735 can be any conventional storage medium that stores program module 730 thereon in tangible form. Client 300 could also be stored on a separate storage medium 735. Examples of storage medium 735 include a floppy disk, a compact disk, a magnetic tape, a read only memory, an optical storage media, universal serial bus (USB) flash drive, a digital versatile disc, or a zip drive. Alternatively, storage medium 735 can be a random access memory, or other type of electronic storage, located on a remote storage system and coupled to computer 705 via communication network 104.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
receiving, via a communication network, first information concerning a telephone call being proposed for a telephone having a first telephone number;
obtaining second information relating to a prior call involving said first telephone number;
obtaining a resultant telephone number, based on said first information and said second information; and
outputting said resultant telephone number, via said communication network.

2. The method of claim 1, wherein said obtaining said resultant telephone number comprises:
formulating a query, based on said first information and said second information; and
receiving said resultant telephone number from a search of a database, based on said query.

3. The method of claim 1, wherein said obtaining said resultant telephone number comprises:
formulating a query, based on said first information;
receiving a plurality of results from a search of a database, based on said query; and
extracting said resultant telephone number from said plurality of results, based on said second information.

4. The method of claim 1,
(a) wherein said obtaining said resultant telephone number comprises:
formulating a query, based on said first information;
receiving a plurality of results from a search of a database, based on said query;
extracting a subset of said plurality of results, based on said second information, wherein said subset includes (i) a telephone number of a first entity that is designated as deserving a preferential treatment, and (ii) a telephone number of a second entity that is not designated as deserving said preferential treatment; and
organizing said subset in a list,
wherein said telephone number of said first entity is positioned earlier in said list than is said telephone number of said second entity, and
wherein said list includes said resultant telephone number, and
(b) wherein said outputting said resultant telephone number comprises:
outputting said list.

5. The method of claim 1,
wherein said prior call was between said first telephone number and a second telephone number, and
wherein said second information comprises information relating to said second telephone number.

6. The method of claim 5, wherein said information relating to said second telephone number comprises a popularity of said second telephone number.

7. The method of claim 6, wherein said popularity comprises a factor selected from the group consisting of:
(a) a number of calls previously conducted between said first telephone number and said second telephone number,
(b) an amount of time spent during calls previously conducted between said first telephone number and said second telephone number,
(c) a number of calls previously conducted between said second telephone number and other telephone numbers, and
(d) an amount of time spent during calls previously conducted between said second telephone number and other telephone numbers.

8. The method of claim 1,
wherein said prior call was between said first telephone number and a second telephone number, and
wherein said second information comprises information relating to a third telephone number with which said second telephone number has previously conducted a call.

9. The method of claim 1,
wherein said prior call was between said first telephone number and a telephone number of a party that belongs to a category of parties, and
wherein said second information includes said category.

10. The method of claim 1, further comprising:
associating an attribute with said first telephone number, based on said first information.

11. The method of claim 10, further comprising:
providing to a user of said telephone, information concerning a service or a product, based on said attribute.

12. A system comprising:
a processor; and
a memory that contains instructions that are readable by said processor, and that control said processor to perform actions of:
receiving, via a communication network, first information concerning a telephone call being proposed for a telephone having a first telephone number;
obtaining second information relating to a prior call involving said first telephone number;
obtaining a resultant telephone number, based on said first information and said second information; and
outputting said resultant telephone number, via said communication network.

13. The system of claim 12, wherein said obtaining said resultant telephone number comprises:
formulating a query, based on said first information and said second information; and
receiving said resultant telephone number from a search of a database, based on said query.

14. The system of claim 12, wherein said obtaining said resultant telephone number comprises:
formulating a query, based on said first information;
receiving a plurality of results from a search of a database, based on said query; and
extracting said resultant telephone number from said plurality of results, based on said second information.

15. The system of claim 12,
(a) wherein said obtaining said resultant telephone number comprises:
formulating a query, based on said first information;
receiving a plurality of results from a search of a database, based on said query;
extracting a subset of said plurality of results, based on said second information, wherein said subset includes (i) a telephone number of a first entity that is designated as deserving a preferential treatment, and (ii) a telephone number of a second entity that is not designated as deserving said preferential treatment; and
organizing said subset in a list,
wherein said telephone number of said first entity is positioned earlier in said list than is said telephone number of said second entity, and
wherein said list includes said resultant telephone number, and
(b) wherein said outputting said resultant telephone number comprises:
outputting said list.

16. The system of claim 12,
wherein said prior call was between said first telephone number and a second telephone number, and
wherein said second information comprises information relating to said second telephone number.

17. The system of claim 16, wherein said information relating to said second telephone number comprises a popularity of said second telephone number.

18. The system of claim 17, wherein said popularity comprises a factor selected from the group consisting of:
(a) a number of calls previously conducted between said first telephone number and said second telephone number,
(b) an amount of time spent during calls previously conducted between said first telephone number and said second telephone number,
(c) a number of calls previously conducted between said second telephone number and other telephone numbers, and
(d) an amount of time spent during calls previously conducted between said second telephone number and other telephone numbers.

19. The system of claim 12,
wherein said prior call was between said first telephone number and a second telephone number, and
wherein said second information comprises information relating to a third telephone number with which said second telephone number has previously conducted a call.

20. The system of claim 12,
wherein said prior call was between said first telephone number and a telephone number of a party that belongs to a category of parties, and
wherein said second information includes said category.

21. The system of claim 12, wherein said actions further comprise:
associating an attribute with said first telephone number, based on said first information.

22. The system of claim 21, wherein said actions further comprise:
providing to a user of said telephone, information concerning a service or a product, based on said attribute.

23. A storage medium comprising instructions that are readable by a processor, and that control said processor to perform actions of:
receiving, via a communication network, first information concerning a telephone call being proposed for a telephone having a first telephone number;
obtaining second information relating to a prior call involving said first telephone number;
obtaining a resultant telephone number, based on said first information and said second information; and
outputting said resultant telephone number, via said communication network.

24. The storage medium of claim 23, wherein said obtaining said resultant telephone number comprises:
formulating a query, based on said first information and said second information; and
receiving said resultant telephone number from a search of a database, based on said query.

25. The storage medium of claim 23, wherein said obtaining said resultant telephone number comprises:
formulating a query, based on said first information;
receiving a plurality of results from a search of a database, based on said query; and
extracting said resultant telephone number from said plurality of results, based on said second information.

26. The storage medium of claim 23,
(a) wherein said obtaining said resultant telephone number comprises:
formulating a query, based on said first information;
receiving a plurality of results from a search of a database, based on said query;
extracting a subset of said plurality of results, based on said second information, wherein said subset includes (i) a telephone number of a first entity that is designated as deserving a preferential treatment, and (ii) a telephone number of a second entity that is not designated as deserving said preferential treatment; and
organizing said subset in a list,
wherein said telephone number of said first entity is positioned earlier in said list than is said telephone number of said second entity, and
wherein said list includes said resultant telephone number, and
(b) wherein said outputting said resultant telephone number comprises:
outputting said list.

27. The storage medium of claim 23,
wherein said prior call was between said first telephone number and a second telephone number, and
wherein said second information comprises information relating to said second telephone number.

28. The storage medium of claim 27, wherein said information relating to said second telephone number comprises a popularity of said second telephone number.

29. The storage medium of claim 28, wherein said popularity comprises a factor selected from the group consisting of:
(a) a number of calls previously conducted between said first telephone number and said second telephone number,
(b) an amount of time spent during calls previously conducted between said first telephone number and said second telephone number,
(c) a number of calls previously conducted between said second telephone number and other telephone numbers, and
(d) an amount of time spent during calls previously conducted between said second telephone number and other telephone numbers.

30. The storage medium of claim 23,
wherein said prior call was between said first telephone number and a second telephone number, and
wherein said second information comprises information relating to a third telephone number with which said second telephone number has previously conducted a call.

31. The storage medium of claim 23,
wherein said prior call was between said first telephone number and a telephone number of a party that belongs to a category of parties, and
wherein said second information includes said category.

32. The storage medium of claim 23, wherein said actions further comprise:
associating an attribute with said first telephone number, based on said first information.

33. The storage medium of claim 32, wherein said actions further comprise:
providing to a user of said telephone, information concerning a service or a product, based on said attribute.
